(19) United States
(12) Patent Application Publication
(10) Pub. No.: US 2010/0106536 A1
(43) Pub. Date: Apr. 29, 2010

(54) FACILITATING ELECTRONIC KNOWLEDGE TRANSFER IN ORGANIZATIONS

(76) Inventor: Mehmet Yildiz, Victoria (AU)

Correspondence Address: Keohane & D'Alessandro, 1881 Western Avenue Suite 180, Albany, NY, 12203, US

(21) Appl. No.: 12/252,668

(22) Filed: Oct. 16, 2008

(51) Int. Cl. G06Q 10/00; G06N 5/02; G06F 7/00; G06F 17/30

(52) U.S. Cl. 705/7; 706/46; 707/E17.055

(57) ABSTRACT

The present invention provides an approach for facilitating (electronic) knowledge transfer in organizations. Specifically, under the present invention, knowledge objects are collected, a set of questions are generated and classified, and a set of checklists are generated. Based on the knowledge objects, response to the questions, and the checklists, a set of analyses is performed, and a resulting set of reports generated. The reports as well as the knowledge objects, questions and/or checklists can be archived for later use.

### FIELD OF THE INVENTION

The present invention generally relates to knowledge transfer. Specifically, the present invention relates to electronic technical and tacit knowledge transfer in an organization.

### BACKGROUND OF THE INVENTION

Transfer of tacit knowledge amongst employees, partners, and customers is critical in all enterprises/organizations. The practice of tacit knowledge transfer has a substantial impact on business. When it is done incorrectly or inadequately, it may cause serious business loss. Yet if it is done correctly and adequately, it will help the business to be profitable. It can affect an organization at many levels.

One specific area of particular importance where seamless knowledge transfer is needed is during the mergers and/or acquisitions. For example, assume a large IT support organization acquires a smaller organization or merges with a similar size enterprise organization. A key issue is that the practitioners may not understand their new customer's business, which was usually not well documented or documented in a different style than they are used to. As such, critical knowledge may be lost with the people who left their organization to be supported.

In addition, the format of knowledge (e.g., in terms of media) can create equally large challenges in knowledge transfer. Since an organization can span various geographies, it is common for the organization to become dependent on various media such as text, diagrams, voice, and video. Not only can documented knowledge can be in a variety of formats but also there is an ongoing maintenance of these records to ensure tacit knowledge is transferred in a timely and efficient manner to meet the business objectives. In each knowledge transfer activity, there can be substantial amount of questions that come to the minds of practitioners. Unclassified questions cause confusion and as such, answers are not obtained in desired manners. This would naturally affect the quality of knowledge transfer.

### SUMMARY OF THE INVENTION

In general, the present invention provides an approach for facilitating (electronic) knowledge transfer in organizations. Specifically, under the present invention, knowledge objects are collected, a set of questions are generated and classified, and a set of checklists are generated. Based on the knowledge objects, response to the questions, and the checklists, a set of analyses is performed, and a resulting set of reports is generated. The reports, as well as the knowledge objects, questions and/or checklists can be archived for later use.

A first aspect of the present invention provides a method for facilitating knowledge transfer in organizations, comprising: collecting internal knowledge objects and external knowledge objects for an organization, and merging the internal knowledge objects and external knowledge objects; classifying a set of questions based on a set of attributes; generating a set of checklists; performing a set of analyses on the internal knowledge objects, the external knowledge objects, responses to the set of questions, and responses to the set of checklists, and merging the set of analyses; and generating a set of reports based on the set of analyses.

A second aspect of the present invention provides a system for facilitating knowledge transfer in organizations, comprising: a module for collecting internal knowledge objects and external knowledge objects for an organization, and merging the internal knowledge objects and external knowledge objects; a module for classifying a set of questions based on a set of attributes; a module for generating a set of checklists; a module for performing a set of analyses on the internal knowledge objects, the external knowledge objects, responses to the set of questions, and responses to the set of checklists, and merging the set of analyses; and a module for generating a set of reports based on the set of analyses.

A third aspect of the present invention provides a computer readable medium containing a program product for fostering knowledge transfer in organizations, the computer readable medium comprising program code for causing a computer system to: collect internal knowledge objects and external knowledge objects for an organization, and merging the internal knowledge objects and external knowledge objects; classify a set of questions based on a set of attributes; generate a set of checklists; perform a set of analyses on the internal knowledge objects, the external knowledge objects, responses to the set of questions, and responses to the set of checklists, and merging the set of analyses; and generate a set of reports based on the set of analyses.

A fourth aspect of the present invention provides a method for deploying an application for fostering knowledge transfer in organizations, comprising: deploying a computer infrastructure being operable to: collect internal knowledge objects and external knowledge objects for an organization, and merging the internal knowledge objects and external knowledge objects; classify a set of questions based on a set of attributes; generate a set of checklists; perform a set of analyses on the internal knowledge objects, the external knowledge objects, responses to the set of questions, and responses to the set of checklists, and merging the set of analyses; and generate a set of reports based on the set of analyses.

A fifth aspect of the present invention provides a method for facilitating knowledge transfer in organizations, comprising: collecting internal knowledge objects and external knowledge objects for an organization, and merging the internal knowledge objects and external knowledge objects; classifying a set of questions based on a set of attributes; generating a set of checklists; performing a set of analyses on the internal knowledge objects, the external knowledge objects, responses to the set of questions, and responses to the set of checklists, and merging the set of analyses; and generating a set of reports based on the set of analyses.

A sixth aspect of the invention provides at least one data processing system for facilitating knowledge transfer in organizations, comprising: at least one memory medium having instructions; at least one bus coupled to the memory medium; and at least one processor coupled to the least one bus that when executing the instructions causes the at least one data processing system to: collect internal knowledge objects and external knowledge objects for an organization, and merging the internal knowledge objects and external knowledge objects; classify a set of questions based on a set of attributes; generate a set of checklists; perform a set of analyses on the internal knowledge objects, the external knowledge objects, responses to the set of questions, and responses to the set of checklists, and merging the set of analyses; and generate a set of reports based on the set of analyses.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative framework for facilitating knowledge transfer according to the present invention.

FIG. 2 depicts a more specific computerized implementation according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:

I. General Description

II. Computerized Implementation

### I. General Description

As used herein, the following terms have the associated meanings:
“Set”—a quantity of at least one.
“Organization”—any individual, group of individuals, and/or entity.

As indicated above, the present invention provides an approach for facilitating (electronic) knowledge transfer in organizations. Specifically, under the present invention, knowledge objects are collected, a set of questions are generated and classified, and a set of checklists are generated. Based on the knowledge objects, response to the questions, and the checklists, a set of analyses is performed, and a resulting set of reports is generated. The reports, as well as the knowledge objects, questions and/or checklists can be archived for later use.

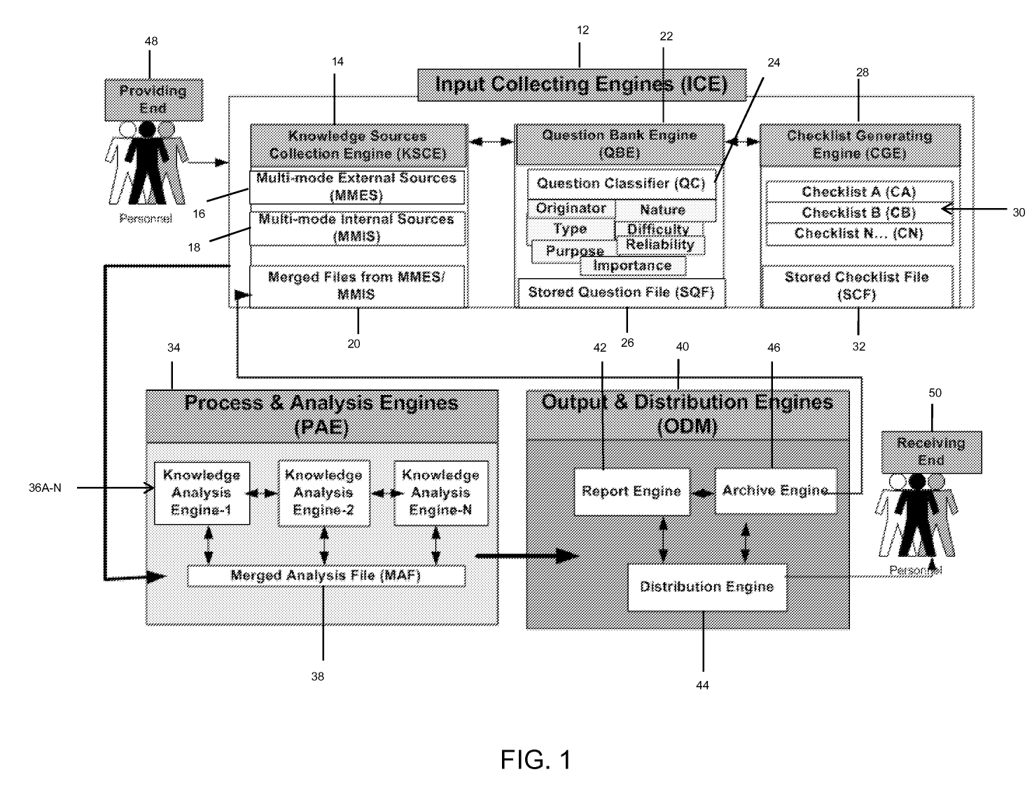

Referring now to FIG. 1, a framework/architecture 10 for facilitating knowledge transfer in organizations is shown. As depicted, framework 10 has three engines. The first engine is an input collection engine (hereinafter ICE 12). As further shown ICE 12 has three components. The first component is called Knowledge Sources Collection Engine (hereinafter KSCE 14), which itself is shown having three elements. The first element called Multi-Mode External Source element (hereinafter MMES 16), which collects external knowledge objects for the organization. Also shown is Multi-Mode Internal Source element (hereinafter MMIS 18), which collects internal knowledge objects for the organization. The third element is an electronic (knowledge) object file called MMES/IS, which is a merged file 20 containing knowledge elements of both MMES 16 and MMIS 18 in a storage unit.

The second component of ICE 12 is called Question Bank Engine (hereinafter QBE 22). As depicted, QBE 22 has two elements. The first element Question Classifier (hereinafter QC 24) collects and classifies required questions in a repository. Classification of the set of questions typically occurs based on one or more attributes such as originator, type, nature, purpose, difficulty, reliability, and importance. The second component shown in QBE 22 is an electronic questions file called Stored Question File (hereinafter SQF 26), which stores all classified questions. The third component of the ICE 12 is called Checklist Generating Engine (hereinafter CGE 28). CGE 28 creates a set of checklists 30 that are stored in an electronic checklist file Storage Checklist File (hereinafter SCF 32). This file keeps all checklists 30 for the knowledge objects in a structured manner. The questions will be posed to individual(s) 48 in the organization who possess the knowledge to be transferred, and the responses will be gathered. The checklists help ensure not only that all pertinent knowledge is gathered, but transferred accordingly.

The second engine shown in framework 10 is called Process and Analysis Engines (hereinafter PAE 34), which includes a set of modules called knowledge analysis engines 36A-N. The quantity of these engines is dependent on the needs and types of knowledge objects to be analyzed and processed. At this stage they are labeled and encapsulated under the names of Knowledge Analysis Engine 1 to N as shown. Regardless, knowledge analysis engines 36A-N perform a set of analyses based the external and internal knowledge objects, responses to the classified questions, and the checklists. The set of analyses (and/or results of the set of analyses) will be stored in an electronic analysis file called Merged Analysis File (hereinafter MAF 38).

The third engine shown in framework 10 is called Output and Distribution Engines (hereinafter ODM 40), which is shown having three components. The first module of ODM is called Report Engine (hereinafter RE 42). This module prepares a set of reports pertaining to the set of analyses. The second module of ODM is the Distribution Engine (hereinafter DE 44), which receives the reports from RE 42 and sends a copy thereof to Archive Engine (hereinafter AE 46). The AE 46, which archives the same. DE 44 can also distribute the reports to recipients 50. As further shown in FIG. 1, AE 46 has a direct link to update the MMES/IS 20 of KSCE 14.

### II. Computerized Implementation

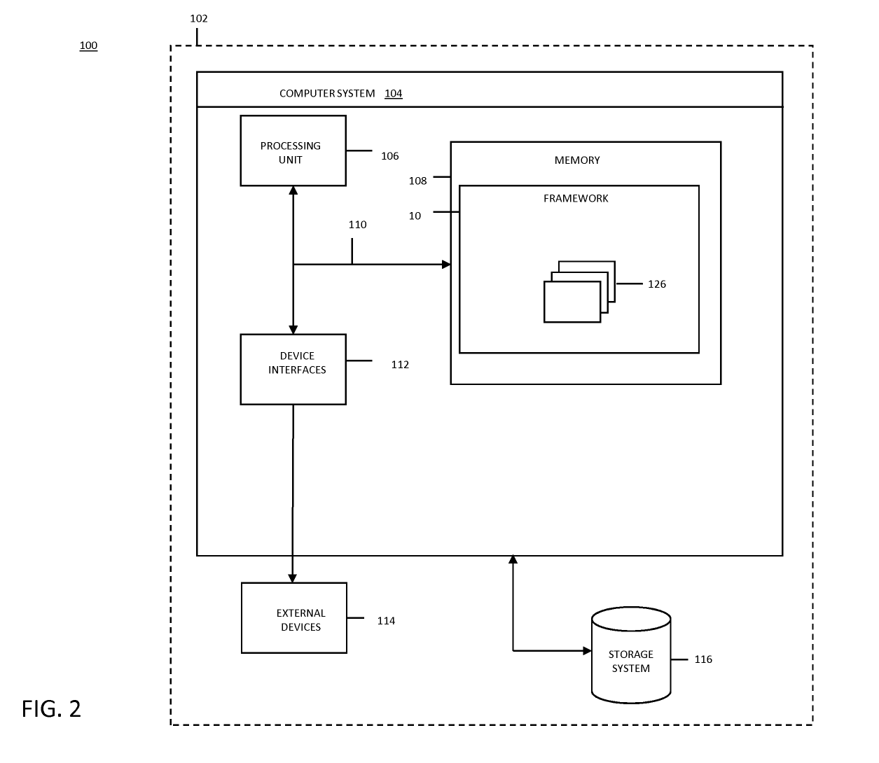

Referring now to FIG. 2, a computerized implementation 100 of the present invention is shown. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others.

Computer system is intended to represent any type of computer system that may be implemented in deploying/realizing the teachings recited herein. It should be understood that any other computers implemented under the present invention will have similar components, but may perform different functions/have different software. As shown, computer system 104 includes a processing unit 106, a memory 108, a bus 110, and device interfaces 112. Further, computer system 104 is shown communicating with one or more external devices 114 that communicate with bus 110 via device interfaces 112. In general, processing unit 106 executes computer program code, such framework 10, which is stored in memory 108 and/or storage system 116. While executing computer program code, processing unit 106 can read and/or write data to/from memory 108, storage system 116, and/or device interfaces 112. Bus 110 provides a communication link between each of the components in computer system 104. Although not shown, computer system 104 could also include I/O interfaces that communicate with: one or more external devices such as a kiosk, a checkout station, a keyboard, a pointing device, a display, etc.); one or more devices that enable a user to interact with computer system 104; and/or any devices (e.g., network card, modem, etc.) that enable computer system 104 to communicate with one or more other computing devices. Although not shown, computer system 104 could contain multiple processing units.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various processes of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, device interfaces 112 can comprise any module for exchanging information with one or more external devices. Still further, it is understood that one or more additional components (e.g., system software, math co-processing unit, etc.) not shown in FIG. 2 can be included in computer system 104.

Storage system 116 can be any type of system capable of providing storage for information under the present invention. To this extent, storage system 116 could include one or more storage devices such as magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system 104.

Shown in memory 108 of computer system 104 is framework 10, which has a set of modules 126. Set of modules 126 generally correspond to the elements of FIG. 1 discussed above and provide the functions of the present invention as described herein. Specifically (among other things), set of modules 126 is configured to: collect internal knowledge objects and external knowledge objects for an organization, and merging the internal knowledge objects and external knowledge objects; classify a set of questions based on a set of attributes; generate a set of checklists; perform a set of analyses on the internal knowledge objects, the external knowledge objects, responses to the set of questions, and responses to the set of checklists, and merging the set of analyses; and/or generate a set of reports based on the set of analyses.

While shown and described herein as an approach for facilitating knowledge transfer, it is understood that the invention further provides various alternative embodiments. For example, in one embodiment, the invention provides a computer-readable/useable medium that includes computer program code to enable a computer infrastructure to facilitate knowledge transfer. To this extent, the computer-readable/useable medium contains program code that implements each of the various processes of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 2) and/or storage system 116 (FIG. 2) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to facilitate knowledge transfer. In this case, the service provider can create, maintain, support, etc., a computer infrastructure, such as computer infrastructure 102 (FIG. 2) that performs the process of the invention for one or more customers. In return, the service provider can receive payment from the customers under a subscription and/or fee agreement and/or the service provider can receive payment from the sale of advertising content to one or more third parties.

In still another embodiment, the invention provides a computer-implemented method to enable a computer infrastructure to facilitate knowledge transfer. In this case, a computer infrastructure, such as computer infrastructure 102 (FIG. 2), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 104 (FIG. 2), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic device system/driver for a particular computing and/or device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or device devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for facilitating knowledge transfer in organizations, comprising:
collecting internal knowledge objects and external knowledge objects for an organization, and merging the internal knowledge objects and external knowledge objects;
classifying a set of questions based on a set of attributes;
generating a set of checklists;
performing a set of analyses on the internal knowledge objects, the external knowledge objects, responses to the set of questions, and responses to the set of checklists, and merging the set of analyses; and
generating a set of reports based on the set of analyses.

2. The method of claim 1, further comprising storing the internal knowledge objects and external knowledge objects in an electronic object file.

3. The method of claim 1, further comprising storing the set of questions in an electronic questions file.

4. The method of claim 1, further comprising storing the set of analyses in an electronic analysis file.

5. The method of claim 1, further comprising archiving the set of reports.

6. The method of claim 1, the set of attributes comprising originator, nature, type, difficulty, purpose, reliability and importance.

7. A system for facilitating knowledge transfer in organizations, comprising:
a module for collecting internal knowledge objects and external knowledge objects for an organization, and merging the internal knowledge objects and external knowledge objects;
a module for classifying a set of questions based on a set of attributes;
a module for generating a set of checklists;
a module for performing a set of analyses on the internal knowledge objects, the external knowledge objects, responses to the set of questions, and responses to the set of checklists, and merging the set of analyses; and
a module for generating a set of reports based on the set of analyses.

8. The system of claim 7, further comprising a module for storing the internal knowledge objects and external knowledge objects in an electronic object file.

9. The system of claim 7, further comprising a module for storing the set of questions in an electronic questions file.

10. The system of claim 7, further comprising a module for storing the set of analyses in an electronic analysis file.

11. The system of claim 7, further comprising a module for archiving the set of reports.

12. The system of claim 7, the set of attributes comprising originator, nature, type, difficulty, purpose, reliability and importance.

13. A computer readable medium containing a program product for facilitating knowledge transfer in organizations, the computer readable medium comprising program code for causing a computer system to:
collect internal knowledge objects and external knowledge objects for an organization, and merging the internal knowledge objects and external knowledge objects;
classify a set of questions based on a set of attributes;
generate a set of checklists;
perform a set of analyses on the internal knowledge objects, the external knowledge objects, responses to the set of questions, and responses to the set of checklists, and merging the set of analyses; and
generate a set of reports based on the set of analyses.

14. The computer readable medium containing the program product of claim 13, the computer readable medium further comprising program code for causing the computer system to store the internal knowledge objects and external knowledge objects in an electronic object file.

15. The computer readable medium containing the program product of claim 13, the computer readable medium further comprising program code for causing the computer system to store the set of questions in an electronic questions file.

16. The computer readable medium containing the program product of claim 13, the computer readable medium further comprising program code for causing the computer system to store the set of analyses in an electronic analysis file.

17. The computer readable medium containing the program product of claim 13, the computer readable medium further comprising program code for causing the computer system to archive the set of reports.

18. The computer readable medium containing the program product of claim 13, the set of attributes comprising originator, nature, type, difficulty, purpose, reliability and importance.

19. A method for deploying an application for facilitating knowledge transfer in organizations, comprising:
deploying a computer infrastructure being operable to:
collect internal knowledge objects and external knowledge objects for an organization, and merging the internal knowledge objects and external knowledge objects;
classify a set of questions based on a set of attributes;
generate a set of checklists;
perform a set of analyses on the internal knowledge objects, the external knowledge objects, responses to the set of questions, and responses to the set of checklists, and merging the set of analyses; and
generate a set of reports based on the set of analyses.

20. The method of claim 19, the computer infrastructure being further operable to archive the set of reports.
